(19) United States
(12) Patent Application Publication
(10) Pub. No.: US 2007/0081275 A1
(43) Pub. Date: Apr. 12, 2007

(54) Actuator and hard disk drive having the same

(76) Inventors: Jeong-il CHUN, Seongnam-si (KR); Yong-kyu Byun, Yongin-si (KR); Cheol-soon Kim, Anyang-si (KR)

Correspondence Address: STANZIONE & KIM, LLP, 919 18TH STREET, N.W., SUITE 440, WASHINGTON, DC, 20006, US

(21) Appl. No.: 11/548,732

(22) Filed: Oct. 12, 2006

(30) Foreign Application Priority Data
Oct. 12, 2005 (KR) 2005-96171
Nov. 29, 2005 (KR) 2005-115056

(51) Int. Cl. G11B 5/54

(52) U.S. Cl. 360/256

(57) ABSTRACT

An actuator and a hard disk drive (HDD) having the same. The actuator of the HDD includes a swing arm to rotate about a pivot and having a suspension with a read/write head mounted on a front end of the swing arm to record and reproduce data , a coil-supporting portion connected to a rear end of the swing arm rotate together with the swing arm to receive voice coil motor (VCM) coil , a magnet positioned above and under the VCM coil to face each other to face the VCM coil, and at least one swing-arm protrusion formed at the rear end of the swing arm to protrude toward the magnet and including a magnetic material so that a bias torque is produced due to an interaction between the at least one swing-arm protrusion and the magnet.

### CROSS-REFERENCE TO RELATED APPLICATIONS

This application claims priority under 35 U.S.C. § 119(a) from Korean Patent Application Nos. 10-2005-0096171 filed on Oct. 12, 2005 and 10-2005-0115056 filed on Nov. 29, 2005 in the Korean Intellectual Property Office, the disclosures of which are incorporated herein in its entirety by reference.

### BACKGROUND OF THE INVENTION

1. Field of the Invention

The present general inventive concept relates to an actuator and a hard disk drive (HDD) having the same, and more particularly, to an actuator to improve a dynamic characteristic, such as loading/unloading, and an impact-resistant characteristic against an external impact, and an HDD having the same.

2. Description of the Related Art

A hard disk drive (HDD) is an information storing apparatus used in computers, for reproducing or recording data on a disk, by using a read/write head. In the HDD, the head is moved to a desired position by an actuator while floating at a desired height above a recording surface of the rotating disk.

FIG. 1 is a perspective view illustrating a structure of a conventional HDD. Referring to FIG. 1, the HDD includes a disk 10 for storing data, a spindle motor 20 for rotating the disk 10, and an actuator 30 for moving a read/write head 34 to a desired position above the disk 10 when recording and reproducing data. The actuator 30 includes a swing arm 32 rotatably connected to an actuator pivot 31, a suspension 33 positioned at a front end of the swing arm 32 for supporting the head 34 and allowing it to be elastically biased toward a surface of the disk 10, and a voice coil motor (VCM) for rotating the swing arm 32. The VCM includes a VCM coil 37 fitted into a coil-supporting portion 36 positioned at a rear end of the swing arm 32, and a magnet 50 positioned above and/or under the VCM coil 37 to face the VCM coil 37.

The VCM rotates the swing arm 32 in a direction according to Fleming's Left Hand Rule by an interaction of a current input to the VCM coil 37 and a magnetic field formed by the magnet 50. When power for operating the HDD is on and the disk 10 starts rotating at a predetermined angular velocity Ω, the VCM rotates the swing arm 32 in a predetermined direction, e.g., a counter-clockwise direction, so that the read/write head 34 is moved above a recording surface of the disk 10. The read/write head 34 is loaded above the disk 10 and floats at a predetermined height from the surface of the disk 10 due to the floating force generated by the rotation of the disk 10. In this state, the read/write head 34 follows a specific track T, for recording or reproducing data on the recording surface of the disk 10.

When the power for operating the HDD is off and the disk 10 stops rotating, the VCM rotates the swing arm 32 in an opposite direction, e.g., a clockwise direction. Then, the read/write head 34 is removed from the recording surface of the disk 10 and is unloaded and parked at a ramp 60 positioned outside the disk 10. In this state, an end-tap 35 protruding at an end of the suspension 33 moves along an outer side of the ramp 60 and is set at a safe position on a supporting surface arranged at the ramp 60.

During a rotation operation of the swing arm 32, a resistance acts on the swing arm 32, for example, a rotational resistance applied to the actuator pivot 31, an elastic bias resistance of a flexible printed circuit 70 attached to a side of the swing arm 32, a frictional resistance between the surface of the ramp 60 and the end-tap 35, and a magnetic resistance acting between the magnet 50 and a retreat ball (not shown) positioned at the rear end of the coil-supporting portion 36. The VCM has to supply a sufficient torque to the swing arm 32 in order that the swing arm 32 overcomes the rotational resistance to rotate. Specifically, a driven current applied to the VCM coil 37 needs to increase to satisfy the required dynamic characteristic such as prompt responsiveness. In this case, however, power consumption of the actuator 30 increases and a driving efficiency becomes lower.

### SUMMARY OF THE INVENTION

The present general inventive concept provides an actuator to improve a dynamic characteristic, such as loading/unloading, and a impact-resistant characteristic against any external impact, and a hard disk drive (HDD) having the same.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an actuator of a hard disk drive, including a swing arm to rotate about a pivot and having a suspension with a read/write head mounted on a front end of the swing arm to read and reproduce data, a coil-supporting portion connected to a rear end of the swing arm to rotate together with the swing arm and to receive a voice coil motor (VCM) coil , and a magnet positioned to face the VCM coil, wherein the swing arm includes, at its rear end, at least one swing arm-protrusion protruding toward the magnet and including a magnetic material so that a bias torque is produced by the magnet and the magnetic material.

The foregoing and/or other aspects of the present general inventive concept may also be achieved by providing a hard disk drive which includes at least one or more disks to store information, a spindle motor to rotate the disk mounted thereon, and an actuator to move a read/write head to record and reproduce data to a desired position above the disk, the actuator including: a swing arm to rotate about a pivot having a suspension with a read/write head mounted on a front end of the swing arm to read and reproduce data, coil-supporting portion connected to a rear end of the swing arm to rotate together with the swing arm and to receive a VCM coil, and a magnet positioned above and/or under the VCM coil to face the VCM coil, wherein the swing arm includes, at its rear end, at least one swing-arm protrusion protruding toward the magnet and including a magnetic material so that a bias torque is produced of the VCM coil and the magnet.

The foregoing and/or other aspects of the present general inventive concept may also be achieved by providing an actuator of a hard disk drive, including a swing arm to rotate about a pivot and a suspension with a read/write head mounted on a front end of the swing arm to read and reproduce data, a coil-supporting portion connected to a rear end of the swing arm to rotate together with the swing arm to receive a VCM coil , and a magnet positioned to face the VCM coil, wherein the swing arm includes, at its rear end, at least one swing-arm protrusion protruding toward the magnet and including a magnetic material, and the magnet includes at least one magnet-protrusion protruding from a body of the magnet toward the swing-arm protrusion so that a bias torque acts on the swing-arm protrusion.

The bias torque may change according to a separating distance between the swing-arm protrusion of the swing arm and the magnet-protrusion of the magnet which are positioned to correspond to each other.

The swing-arm protrusion and the magnet-protrusion may be aligned with each other, so that the separating distance therebetween is shortest when the read/write head enters a ramp for parking.

The foregoing and/or other aspects of the present general inventive concept may also be achieved by providing a hard disk drive which includes at least one or more disks to store information, a spindle motor to rotate the disk mounted thereon, and an actuator to move a read/write head to record and reproduce data to a desired position above the disk, the actuator including a swing arm to rotate about a pivot a suspension with a read/write head mounted on a front end of the swing arm to read and reproduce data, a coil-supporting portion connected to a rear end of the swing arm to rotate together with the swing arm and to receive a VCM coil , and a magnet positioned above and/or under the VCM coil to face the VCM coil, wherein the swing arm includes, at its rear end, at least one swing-arm protrusion protruding toward the magnet and including a magnetic material, and the magnet includes at least one magnet-protrusion protruding from a body of the magnet toward the swing-arm protrusion so that a bias torque acts on the swing-arm protrusion.

The foregoing and/or other aspects of the present general inventive concept may also be achieved by providing a hard disk drive which includes at least one disk to store information, a spindle to rotate the at least one disk, and an actuator to move a read/write head with respect to the at least one disk, the actuator including a swing arm to rotate about a pivot, and having a suspension with a read/write head at a front end of the swing arm and a coil-supporting portion with a VCM coil at a rear end of the swing arm, a magnet disposed to face the VCM coil to generate a main torque with the magnet to rotate the swing arm, and a protrusion formed on the swing arm to generate a bias torque with the magnet to overcome a resistance applied to the swing arm when the swing arm rotates.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a structure of a conventional hard disk drive (HDD);

FIG. 2 is a plan view illustrating an HDD according to an embodiment of the present invention;

FIG. 3 is a plan view illustrating an actuator of the HDD of FIG. 2 when a read/write head is loaded above a disk;

FIG. 4 a plan view illustrating the actuator of the HDD of FIG. 2 when the read/write head is unloaded and enters a ramp;

FIG. 5 a plan view illustrating the actuator of the HDD of FIG. 2 when the read/write head is parked at the ramp;

FIG. 6 is a perspective view illustrating a position of a magnet in the actuator of FIG. 2;

FIG. 7 is a perspective view illustrating positions of a swing-arm protrusion of a swing arm and a magnet-protrusion of a magnet in the actuator of FIG. 2; and

FIG. 8 is a graph illustrating distribution of a bias torque acting on the swing arm, according to a rotating angle of the swing arm, by comparing a conventional actuator and the actuator according to the present embodiment.

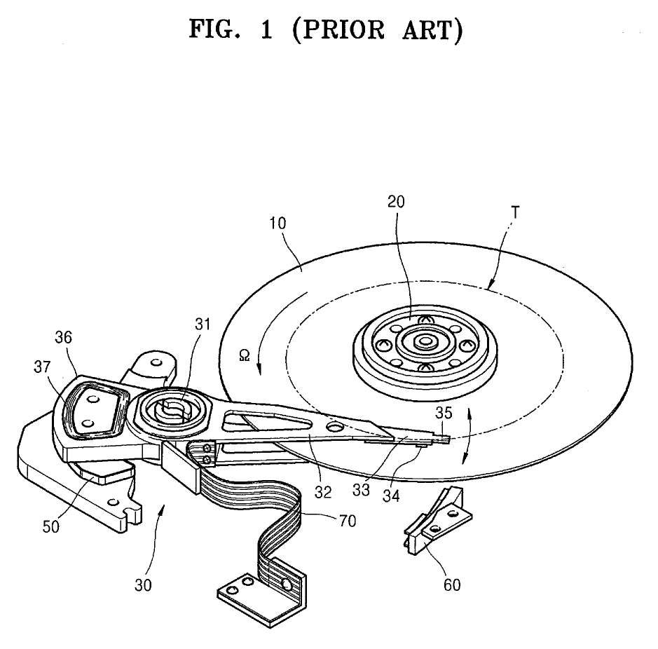

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

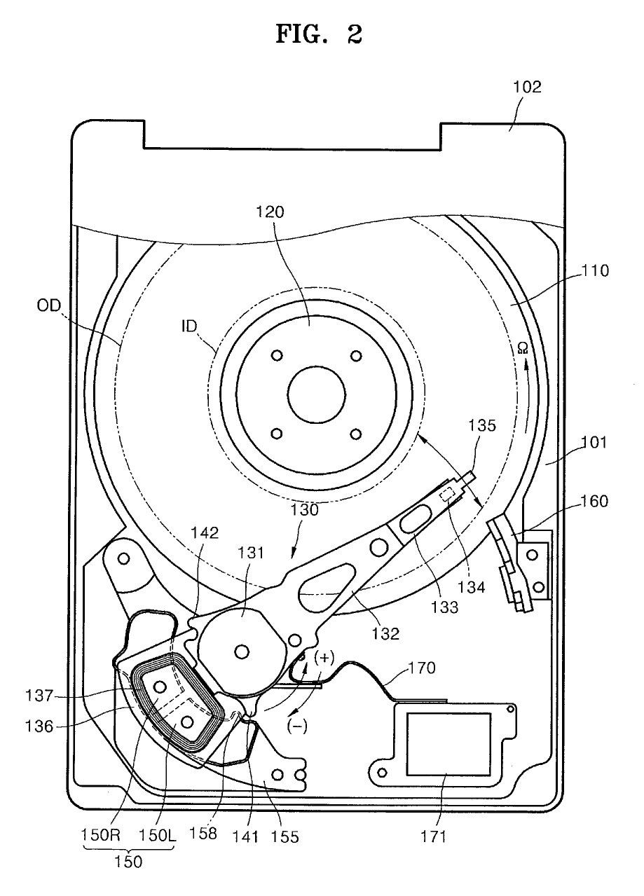

An actuator and a hard disk drive (HDD) having the same, according to an embodiment of the present invention, will now be described more fully hereinafter with reference to the accompanying drawings. FIG. 2 is a plan view illustrating a schematic structure of an HDD according to an embodiment of the present invention. Referring to FIG. 2, the HDD includes a spindle motor 120 to rotate a disk 110 to store data, and an actuator 130 to move a read/write head 134 to record and reproduce the data on and from the disk 110, to a desired position above the disk 110.

The spindle motor 120 is installed on a base member 101 of the HDD. One or more disks 110 are mounted on the spindle motor 120. The disk 110 rotates by the spindle motor 120 at a predetermined angular velocity Ω. A cover member 102 is coupled to the base member 101 to accommodate elements, for example, the disk 110, the spindle motor 120, and/or the actuator 130.

The actuator 130 includes an actuator pivot 131 installed on the base member 101, a swing arm 132, a suspension 133, the read/write head 134 disposed on an end-tap 135 of the suspension 133, a coil-supporting portion 136, and a voice coil motor (VCM). The swing arm 132 is rotatably connected to the actuator pivot 131. The suspension 133 is connected to a front end of the swing arm 132 and supports the read/write head 134 to be elastically biased toward a surface of the disk 110. The coil-supporting portion 136 is fitted into a rear end of the swing arm 132.

The VCM supplies a driving force to rotate the swing arm 132 and rotates the swing arm 132 in a direction according to Fleming's Left Hand Rule by an interaction of a current input to a VCM coil 137 and a magnetic field formed by a magnet 150. The VCM coil 137 is fitted into the coil-supporting portion 136. The magnet 150 may be positioned above and under the VCM coil 137 such that the magnet 150 and the VCM coil 137 face each other. A yoke 155 to support the magnet 150 is positioned on the base member 101. The magnet 150 has a shape of an arc of desired curvature, corresponding to a track of the VCM coil 137 rotating together with the swing arm 132 with respect to a rotating axis of the actuator pivot 131. The magnet 150 may be longitudinally or in a circumferential direction of the rotating axis divided into two approximately equal parts, i.e., a first magnetic pole 150L on the left of the actuator pivot 31 and a second magnetic pole 150R on the right thereof. The first magnetic pole 150L on the left and the second magnetic pole 150R on the right are positioned to be adjacent to each other and have polarities opposite to each other. The VCM coil 137 is positioned in a magnetic flux space formed by the magnet 150 and rotates clockwise or counter-clockwise in the magnetic flux space according to a direction of an applied driving current to the VCM coil 137.

One side of the actuator 130 is connected to a flexible printed circuit 170. Through the flexible printed circuit 170, signals are transmitted to move the actuator 130 so as to be loaded above the disk 110 or remove it from the disk 110 so as to be unloaded outside the disk 110, in accordance with an operation signal or stop signal of the signals. The flexible printed circuit 170 receives a driving signal or power controlled by a circuit board (not shown) positioned under the base member 101. For this purpose, a bracket 171 to connect the flexible printed circuit 170 and the circuit board is installed in a corner of one side of the base member 101.

The spindle motor 120 and the actuator 130 are positioned in an internal space arranged by the base member 101 and the cover member 102 which are connected to each other. The base member 101 and the cover member 102 protect component parts positioned in the internal space by preventing infiltration of foreign materials, and reduce a driving noise that may be transferred to an outside thereof.

When power for operating the HDD is on and the disk 110 starts rotating, the VCM rotates the swing arm 132 in a predetermined direction, e.g., a counter-clockwise direction, so that the read/write head 134 is loaded above a recording surface of the disk 110. The read/write head 34 floats at a predetermined height from the surface of the disk 110 due to a floating force generated by the rotation of the disk 110. In this state, the read/write head 34 follows a specific track of the disk 110, to record or reproduce data on the recording surface of the disk 110. The recording surface of the disk 110 represents a partial region on the surface of the disk 110 where information is effectively stored. In general, the recording surface of the disk 110 does not indicate the entire surface of the disk 110. That is, an inner edge in a radial direction of the disk 110 is assigned to connect the disk 110 with the spindle motor 120, and an outer edge of the disk 110 is assigned to park the read/write head 134. Thus, the region between an inner diameter (ID) and an outer diameter (OD) can be defined as the recording surface of the disk 110 to store information effectively.

When the power for operating the HDD is off and the disk 110 stops rotating, the VCM rotates the swing arm 32 in an opposite direction, e.g., a clockwise direction, so that the read/write head 134 is remove from the recording surface of the disk 110 and is parked at a ramp 160 positioned outside the disk 110. The actuator 130 further includes a first swing arm protrusion 141, a second swing arm protrusion 142, and a magnet protrusion 158 which will be described later.

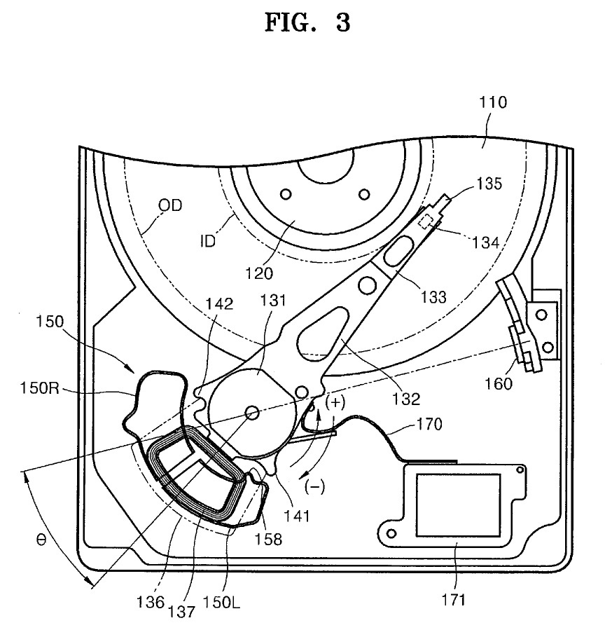

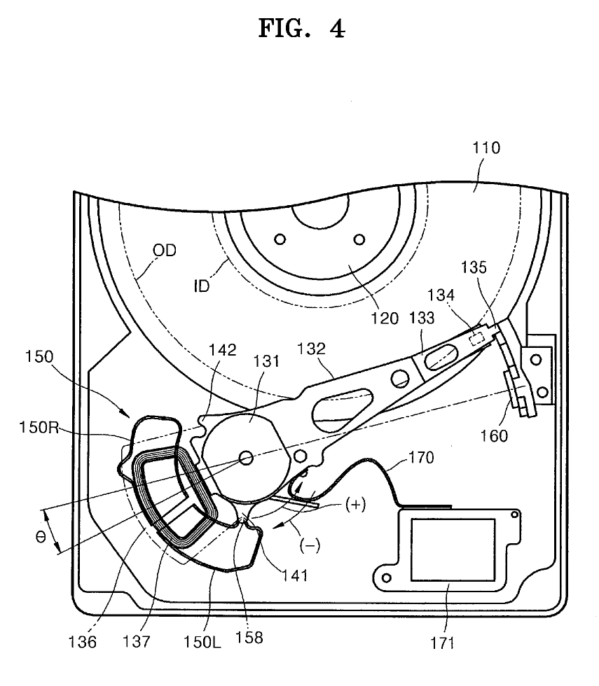

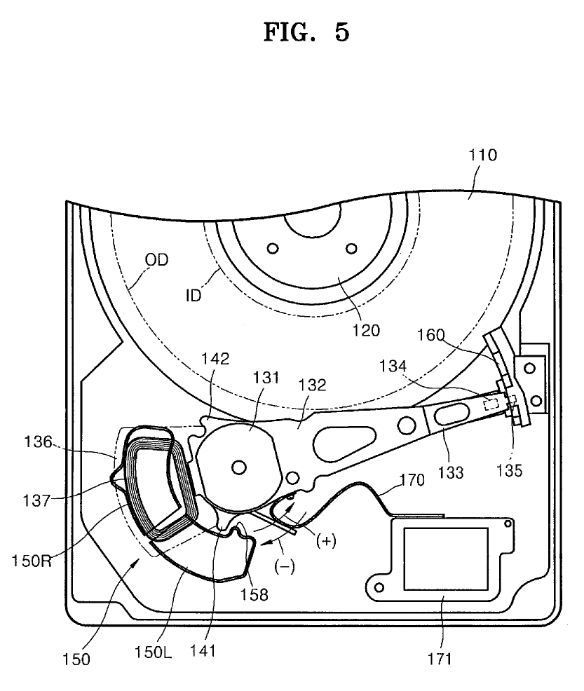

FIGS. 3 through 5 are plan views illustrating the actuator of the HDD of FIG. 2. These figures illustrate sequentially an unloading operation of the actuator according to a rotation angle. FIG. 3 illustrates the read/write head 134 loaded above the disk 110. FIG. 4 illustrates the read/write head 134 positioned near the OD of the disk 110 when the read/write head 134 is being unloaded and enters the ramp 160. FIG. 5 illustrates the read/write head 134 set at the ramp 160. In regard to the rotation direction of the swing arm 132 as shown, a positive (+) direction indicates a direction in which the swing arm 132 is loaded above the disk 110, i.e., a counter-clockwise direction, and a negative (−) direction indicates a direction in which the swing arm 132 is unloaded from above the disk 110 toward the ramp 160, i.e., in a clockwise direction.

Referring to FIGS. 3 though 5, the first swing-arm protrusion 141 protruding toward the magnet 150 is positioned at the rear end of the swing arm 132. The first swing-arm protrusion 141 protrudes toward the first magnet pole 150L of the magnet 150. The first swing-arm protrusion 141 includes a magnetic material for acting on the magnet 150 and is attracted to a negative (−) direction by the first magnetic pole 150L with respect to the rotation axis.

For example, when the read/write head 134 is positioned above the disk 110 as illustrated in FIG. 3, a negative (−) directional bias torque from the first magnetic pole 150L acts on the first swing-arm protrusion 141, and contributes to the unloading of the read/write head 134. In order for the read/write head 134 to be unloaded toward the ramp 160, it is necessary to overcome a rotational load, such as a frictional torque with the ramp 160, a bias torque caused by the flexible printed circuit 170 attached to one side of the actuator 130, and a pivot torque of the actuator pivot 131. A torque (T) which the VCM provides to the swing arm 132 is defined by a current (i) applied to the VCM coil 137 and a torque constant (Kt) determined by a structure of the VCM, as shown in the following Formula:
T=Kt×i

The torque constant (Kt) is a fixed appropriate value which does not change with respect to the designed VCM, that is, the magnetic force of the magnet 150 or the winding number of the VCM coil 137. It is not desirable to optionally change the torque constant (Kt) because it influences the whole price or size of the HDD. In the case of increasing the applied current (i) to increase the torque of the swing arm 132, the power consumption increases and the circuit board needs to be redesigned for the high current. However, since the actuator according to the present embodiment is provided with the swing-arm protrusion 141 having the bias torque in the unloading direction or negative (−) direction, it is possible to obtain a desired torque, without any increase in manufacturing cost or power consumption.

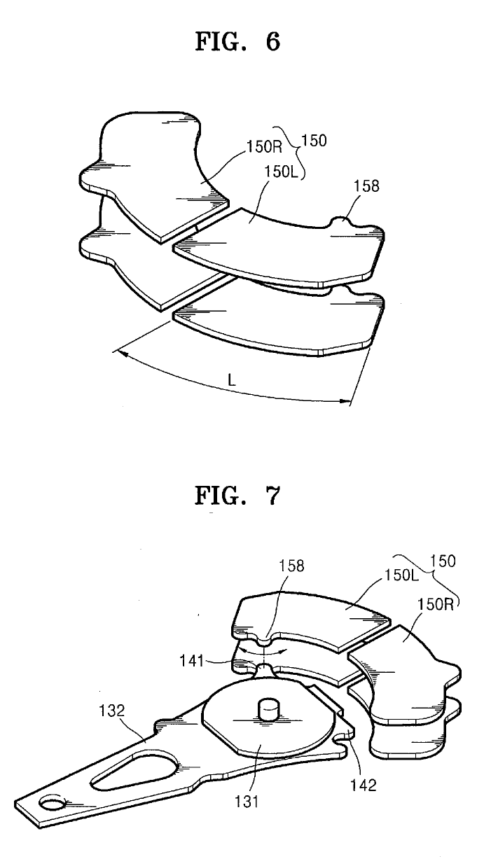

Referring to FIG. 6, the magnets 150 may be positioned, for example, above and under the VCM coil to face each other and provides a space therebetween to accommodate the VCM coil. The VCM coil and the magnets 150 have major surfaces disposed parallel to face each other to generate a field to move the swing arm 132 with respect to the magnets 150 or the disk 110. The VCM coil positioned between the magnets 150 rotates when electrically interacting with the magnets 150. In the present embodiment, a magnet-protrusion 158 protruding toward the swing arm 132 is formed in the magnet 150. For example, the magnet-protrusion 158 protrudes near a corner of the first magnetic pole 150L. However, the magnet-protrusion 158 may be formed at one or more positions, along a length L of the magnet 150 having a circumferential shape. The present general inventive concept is not limited to the position or number of the magnet-protrusions. The first swing-arm protrusion 141 and the magnet-protrusion 158 may protrude in a direction parallel to the major surface of the magnet, 130 or a plain formed by the rotation of the swing arm 132. The first swing-arm protrusion 141 may have an angle with the major surface of the magnets 150 or the VCM coil.

As described above, the first swing-arm protrusion 141 of the swing arm 132 is attracted by the adjacent magnet 150 and receives the bias torque in the unloading direction. Portions other than the magnet-protrusion 158 of the magnet 150 magnetically attract the VCM coil and the swing arm 132 in an almost lateral direction with respect to the swing-arm protrusion 141 of the swing arm 132. However, the magnet-protrusion 158 magnetically attracts the swing-arm protrusion 141 of the swing arm 132 in a direction in which the magnet-protrusion 158 faces the swing-arm protrusion 141, thereby providing a relatively large bias torque to the swing arm 132. Thus, the bias torque acting on the swing arm 132 varies according to a distance between the magnet-protrusion 158 of the magnet 150 and the swing-arm protrusion 141 of the swing arm 132. The first swing-arm protrusion 141 of the swing arm 132 and the magnet-protrusion 158 of the magnet 150 are close to or far from each other according to the rotation of the swing arm 132. The largest bias torque acts on the swing arm 132 when the swing-arm protrusion 141 of the swing arm 132 and the magnet-protrusion 158 of the magnet 150 are closest to each other as illustrated in FIG. 4, for example, when the swing-arm protrusion 141 of the swing arm 132 and the magnet-protrusion 158 of the magnet 150 are positioned to be vertically aligned with each other as illustrated in FIG. 7 (which is an enlarged view of essential parts of FIG. 4,). When the distance between the swing-arm protrusion 141 of the swing arm 132 and the magnet-protrusion 158 of the magnet 150 are relatively far from each other as illustrated in FIGS. 3 and 5, the magnetic attraction therebetween decreases accordingly and the bias torque acting on the swing arm 132 is relatively small.

That is, according to an interaction of the magnet 150 and the VCM coil 137, the swing arm rotates in the negative direction, so that the distance becomes shorter, and the magnetic attraction increases to overcome the resistance. When the distance increases as illustrated in FIG. 5, the magnetic attraction decreases.

As illustrated in FIG. 4, when the disk 110 stops rotating and the read/write head 134 is being unloaded, the end-tap 135 positioned at the end of the suspension 133 moves to the outside of the disk 110 and is driven along the supporting surface of the ramp 160 to enter the ramp 160. The suspension 133 comes into contact, under desired pressure, with the supporting surface of the ramp 160, by the elasticity of the suspension 133. Thus, a frictional force acts between the end-tap 135 and the ramp 160. Here, if the distance between the swing-arm protrusion 141 of the swing arm 132 and the magnet-protrusion 158 of the magnet 150 is designed to be as short as possible so that the largest bias torque is generated when the end-tap 135 enters the ramp 160, the frictional resistance of the ramp 160 acting on the end-tap 135 is overcome by the generated bias torque, and the unloading dynamic characteristic is improved. For example, if the swing-arm protrusion 141 of the swing arm 132 and the magnet-protrusion 158 of the magnet 150 are designed to vertically overlap each other as illustrated in FIG. 4, the problem concerning the frictional resistance of the ramp 160 is rectified.

Furthermore, to secure the impact-resistant characteristic of the HDD, the read/write head 134 may not float higher than a predetermined height from the surface of the disk 110. In this regard, a gram load (for example, a load of the head 134 and the end-tap 135) of the suspension 133 elastically pressing the read/write head 134 toward the surface of the disk 110 may be increased to prevent a head slap. However, since the gram load of the suspension 133 hinders the unloading characteristic due to the frictional resistance with the ramp 160, the increase of the gram load may be determined by considering the effect of the rotational resistance upon the unloading. In the HDD according to the present embodiment, although the gram load of the suspension 133 increases, it is possible to obtain the unloading characteristic satisfying a permissible standard of the actuator 130 of the HDD, by using the bias torque between the swing arm 132 and the magnet 150. Thus, the impact-resistant characteristic may be favorably improved by increasing the gram load of the suspension 133.

In case of an emergency, such as when the power supplied to the HDD is suddenly cut or when the HDD is inadvertently dropped to a position during handling the HDD, the read/write head 134 which has been recording or reproducing data above the disk 110 has to quickly move to a safe parking position. When the HDD having no protective measures is dropped or impacted, the read/write head 134 impacts on the surface of the disk 110, thereby causing a head slap. Thus, the data stored on the disk 110 is damaged and cannot be reproduced, or the read/write head 134 is damaged and cannot perform its functions. Considering such an emergency, the HDD may additionally include an emergency parking function of quickly moving the read/write head 134 to the parking position by applying a greatest available current to the actuator 130. In the present embodiment, a minimum time required for unloading can be achieved, by simply changing the shape of the swing arm 132 and/or the magnet 150, without causing any inconvenience of re-designing a power supplying circuit to increase the greatest available current.

When the read/write head 134 is loaded above the disk 110 for recording or reproducing information by following a specific track between the OD and the ID, if the bias torque toward the ramp 160 acts on the swing arm 132, a tracking error may occur, so that the read/write head 148 breaks away from the track. To prevent the tracking error, a desired torque may be applied in the opposite direction with respect to the bias torque acting in the unloading direction. This will be described in detail below.

The rear end of the swing arm 132 may include a second swing-arm protrusion 142 in addition to the first swing-arm protrusion 141. The second swing-arm protrusion 142 protrudes toward the magnet 150 and includes a magnetic material for acting on the magnet 150. While the first swing-arm protrusion 141 protrudes toward the left (first) magnetic pole 150L, the second swing-arm protrusion 142 protrudes toward the right (second) magnetic pole 150R as illustrated in FIGS. 2 and 7. The second swing-arm protrusion 142 is acted upon in the positive (+) direction by a torque from the magnet 150R positioned on the right. That is, when the read/write head 134 is parked at the ramp 160 as illustrated in FIG. 5, the bias torque in the positive (+) direction acts on the second swing-arm protrusion 142 and assists the loading of the swing arm 132. As a result, upon loading, the dynamic characteristic of the swing arm 132 is improved.

Furthermore, since the second swing-arm protrusion 142 induces the bias torque in the opposite direction to that of the first swing-arm protrusion 141, the bias torque in both positive (+) and negative (−) directions can be balanced to a certain extent. Using the bias torque, it is possible to reduce the tracking error that occurs when the read/write head 134 breaks away from the track being followed. Like the first magnetic pole 150L, the second magnetic pole 150R may include one or more magnet-protrusions (not shown) to correspond to the second swing-arm protrusion 142. These magnet-protrusions 142 apply a strong magnetic bias to the second swing-arm protrusion, which contribute, for example, to the loading operation.

The first swing-arm protrusion 141 and the second swing-arm protrusion 142 are magnetic so that, a magnetic interaction may occur with the magnet 150. The first and second swing-arm protrusions 141 and 142 may be made of a magnetic material, for example, SUS 430, or a material that has no magnetism or has very weak magnetism but becomes magnetized during a manufacturing process, for example, SUS 304su or SUS 301. However, when the swing-arm protrusion having magnetism is exposed to the magnetic disk on which information is magnetically recorded, the existing data recorded may be affected, so that data may be partially deleted or cannot be reproduced. Thus, the magnetic intensity of the swing-arm protrusion may be regularly limited, considering its position relative to the magnetic disk.

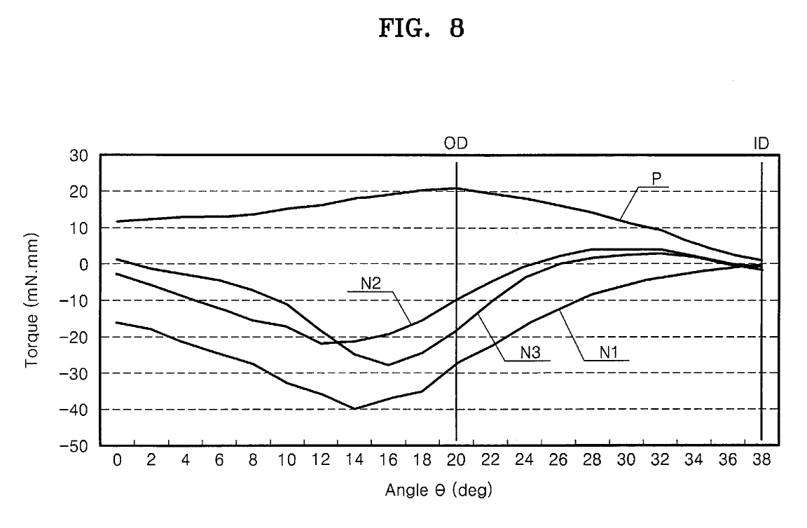

FIG. 8 illustrates distribution of a bias torque acting on the swing arm 132, according to a rotation angle (θ) of the swing arm 132. The bias torque is a torque acting on the swing arm 132 when the VCM is not in operation, that is, when a driving current is not applied to the VCM coil 137. A profile ‘P’ indicates the bias torque in a conventional HDD. A profile ‘N1’ indicates the bias torque in Case 1 of the present embodiment in which the first swing-arm protrusion 141 is formed at the rear end of the swing arm 132. A profile ‘N2’ indicates the bias torque in Case 2 of the present embodiment in which the first swing-arm protrusion 141 and the second swing-arm protrusion 142 are formed at the rear end of the swing arm 132. A profile ‘N3’ indicates the bias torque in Case 3 of the present embodiment in which the first swing-arm protrusion 141 and the second swing-arm protrusion 142 are formed at the rear end of the swing arm 132, and the magnet-protrusion 158 to interact with the first swing-arm protrusion 141 is formed in the magnet 150. A horizontal axis represents the rotation angle (θ) of the swing arm 132. When the swing arm 132 is parked at the ramp 160 (in FIG. 5), the rotating angle (θ) of the swing arm 132 may be set as 0, when the swing arm 132 rotates toward the disk 110 such that the read/write head 134 of its front end is positioned in the OD, the rotating angle (θ) of the swing arm 132 may be about 20 degrees, and when the swing arm 132 further rotates such that the read/write head 134 is positioned in the ID, the rotating angle (θ) of the swing arm 132 may be about 38 degrees.

Referring to FIG. 8, in a conventional HDD (Profile ‘P’) without a swing-arm protrusion and/or a magnet-protrusion, it is noted that the torque varies according to a rotational state of the swing arm 132 but the positive (+) directional bias torque does not vary. This indicates that the swing arm 132 is biased in the positive (+) direction to load the read/write head 134, i.e., toward the disk 110. The positive (+) directional bias torque is helpful for the dynamic characteristic upon loading, for example, the responsiveness to signals or the driving efficiency, but it acts as a rotational load to be overcome during unloading, causing a considerable degradation of the dynamic characteristic during unloading.

In Case 1 of the present embodiment (Profile ‘N1’), a negative (−) bias torque continuously acts on the swing arm 132. This indicates that the swing arm 132 is biased in the negative (−) direction during unloading the read/write head 134, i.e., toward the ramp 160. It is noted that a direction of the bias torque is reversed in Case 1, compared to in a conventional HDD. According to the present embodiment, the first swing-arm protrusion 141 is added to the rear end of the swing arm 132. That is, the magnetic force acting between the first swing-arm protrusion 141 and the magnet 150L has a great influence on the bias torque acting on the swing arm 132. In Case 1, a maximum bias torque of about 40 mN.mm is provided in the opposite direction to the direction of the maximum bias torque of about 20 mN.mm in the conventional HDD.

In Case 2 of the present embodiment (Profile ‘N2’), the negative (−) bias torque acts in most regions. However, compared to Profile ‘N1’ of Case 1 in which only the first swing-arm protrusion 141 is formed in the swing arm 132, it is noted that the strength of the bias torque may be significantly reduced. In Case 2 in which the first swing-arm protrusion 141 and the second swing-arm protrusion 142 are formed, the strength of the bias torque may be reduced to about 20 mN.mm, which is half a maximum bias torque of about 40 mN.mm in Case 1 having only the first swing-arm protrusion 141. That is, when the second swing-arm protrusion 142 is formed, since the bias torque is reduced upon unloading, the dynamic characteristic upon unloading may be adversely affected to a certain extent. However, upon loading, the negative (−) directional bias torque acting in the opposite direction acts as the rotational load. Thus, the strength of the bias torque may be limited within a desired range, considering the dynamic characteristic upon loading. To overcome this limitation, the second swing-arm protrusion 142 in addition to the first swing-arm protrusion 141 is formed at the rear end of the swing arm 132.

In Case 2, when the read/write head 134 is loaded above the disk 110, i.e., when the rotation angle (θ) of the swing arm 132 is within the range the OD (θ=20 degrees) and the ID (θ=38 degrees), the bias torque acting on the swing arm 132 remains at a low level. This low level is due to the second swing-arm protrusion 142 to induce the opposite directional bias torque in addition to the first swing-arm protrusion 141 being formed in the swing arm 132, thereby limiting the bias torque within a certain range. Specifically, since the bias torque acting on the swing arm 132 maintains the minimum level when the read/write head 134 is loaded over the disk 110, it is possible to prevent the tracking error that occurs when the read/write head 134 breaks away from the track being followed.

In Case 3 of the present embodiment, (Profile ‘N3’) in which the magnet-protrusion 158 is formed at one side of the magnet 150 so as to correspond to the first swing-arm protrusion 141 of the swing arm 132, it is noted that the negative (−) bias torque in the unloading direction may be greatly strengthened. In Case 2 (Profile ‘N2’) in which no change in the shape of the magnet 150 occurs, the maximum value of the bias torque is about 20 mN.mm. Compared to Case 2, in Case 3 having the magnet-protrusion 158 in the magnet 150, the maximum bias torque is about 30 mN.mm. This is because the magnet-protrusion 158 of the magnet 150 acts as a strong magnetic attraction in the unloading direction, with respect to the first swing-arm protrusion 141 of the swing arm 132. When the bias torque is at a maximum, the rotation angle (θ) of the swing arm 132 is about 16 degrees. At this angle, the distance between the swing-arm protrusion 141 of the swing arm 132 and the magnet-protrusion 158 of the magnet 150 is at a minimum. The maximum bias torque can be provided by suitably designing the position of the magnet-protrusion 158, taken along the longitudinal direction of the magnet 150, for example, when the read/write head 134 enters the ramp 160.

According to the actuator of the present embodiment and the HDD having the same, it is possible to improve a dynamic characteristic such as the promptness of response or the efficiency of driving by providing the bias torque in the loading/unloading operation of the actuator, and to improve an impact-resistant characteristic of a drive apparatus by quickly completing an urgent protective measure against impact in an emergency. Specifically, in the unloading operation, the impact between the head and the disk caused by the head slap can be prevented, by sufficiently securing the margin of the driving torque and thus, increasing the gram load of the suspension.

Furthermore, according to the present embodiment, it is possible to design a profile of the bias torque, which satisfies the requirement specification, by controlling the separating distance between the swing-arm protrusion of the rotating swing arm and the magnet-protrusion of the magnet. For example, the maximum bias torque can be provided by narrowing the separating distance between the swing-arm protrusion and the magnet-protrusion at the point in time of entering the ramp when the frictional resistance comes into affect upon unloading. The tracking error caused due to the bias torque can be reduced by relatively widening the separating distance between the swing-arm protrusion and the magnet-protrusion when the read/write head is loaded above the disk.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An actuator of a hard disk drive, comprising:
a swing arm to rotate about a pivot and having a suspension with a read/write head mounted on a front end of the swing arm to read and reproduce data;
a coil-supporting portion connected to a rear end of the swing arm to rotate together with the swing arm, and to receive a voice coil motor (VCM) coil;
a magnet positioned to face the VCM coil; and
at least one swing-arm protrusion formed at a portion of the rear end of the swing arm to protrude toward the magnet and including a magnetic material so that a bias torque is produced due to an interaction with the magnet.

2. The actuator of claim 1, wherein the magnet comprises a first magnetic pole and a second magnetic pole which are positioned so as to be laterally adjacent to each other and have polarities opposite to each other.

3. The actuator of claim 2, wherein the swing-arm protrusion protrudes toward the first magnetic pole positioned, so that a clockwise bias torque acts on the swing arm as the bias torque.

4. The actuator of claim 2, wherein the swing-arm protrusion protrudes toward the second magnetic pole positioned, so that a counter-clockwise bias torque acts on the swing arm as the bias torque.

5. The actuator of claim 2, wherein the at least one swing arm-protrusion comprises a first swing-arm protrusion to protrude toward the first magnetic pole and a second swing-arm protrusion to protrude toward the second magnetic pole, so that a clockwise bias torque and a counter-clockwise bias torque act on the swing arm at the same time.

6. The actuator of claim 1, wherein the magnet is positioned above and/or under the VCM coil to face the VCM coil.

7. The actuator of claim 1, wherein the magnet comprises at least one magnet-protrusion protruding from a body of the magnet toward the swing-arm protrusion so that the bias torque acts on the swing-arm protrusion.

8. The actuator of claim 7, wherein the magnet comprises a first magnet pole and a second magnet pole, and the magnet-protrusion is formed in the first magnetic pole toward which the swing-arm protrusion protrudes, so that the magnet-protrusion and the swing-arm protrusion correspond to each other.

9. The actuator of claim 8, wherein the swing arm comprises an additional swing-arm protrusion protruding toward the second magnetic pole.

10. The actuator of claim 9, wherein the second magnetic pole comprises an additional magnet-protrusion protruding toward the additional swing-arm protrusion.

11. The actuator of claim 7, wherein the bias torque changes according to a separating distance between the swing-arm protrusion of the swing arm and the magnet-protrusion of the magnet which are positioned to correspond to each other.

12. The actuator of claim 7, wherein the swing-arm protrusion and the magnet-protrusion are aligned with each other, so that the separating distance therebetween is shortest when the read/write head enters a ramp for parking.

13. The actuator of claim 1, wherein at least one of the coil-supporting portion and the rear end of the swing arm is made of a non-magnetic material, and the at least one swing-arm protrusion is formed on the non-magnetic material.

14. The actuator of claim 1, wherein the magnet and the VCM coil are formed in a circumferential direction of the pivot to relatively rotate about the pivot, and the swing-arm protrusion is formed on the rear end of the swing arm such that a distance between the swing-arm protrusion and the magnet varies to cause the bias torque to vary.

15. The actuator of claim 1, wherein the VCM coil generates a main torque with the magnet such that the swing arm rotates with respect to the pivot, and the swing-arm protrusion generates the bias torque with the magnet to the swing arm.

16. The actuator of claim 15, wherein the swing arm moves between a data zone and a parking zone, and the bias torque is equal to or greater than a resistance generated when the swing arm moves.

17. The actuator of claim 15, wherein the bias torque is greater than a resistance generated exerted on the swing arm when the swing arm move from the data zone to the parking zone greater than a resistance when the swing arm moves from the data zone.

18. The actuator of claim 1, wherein the swing-arm protrusion is disposed in a first position where the swing-arm protrusion is away from the magnet by a first distance, a second position where the swing-arm protrusion overlaps the magnet, by a first area, and a third position when the swing-arm protrusion overlaps the magnet by a second area.

19. The actuator of claim 18, wherein the swing-arm protrusion generates a first bias torque in the first position, a second bias torque in the second position, and a third bias torque in the third position.

20. A hard disk drive which includes at least one disk to store information, a spindle motor to rotate the at least one mounted thereon, and an actuator to move a read/write head to record and reproduce data to and from a desired position above the at least one or more disks, the actuator comprising:
a swing arm to rotate about a pivot having a suspension with a read/write head mounted on a front end of the swing arm to record and reproduce data;
a coil-supporting portion connected to a rear end of the swing arm to rotate together with the swing arm, and to receive a VCM coil;
a magnet positioned to face the VCM coil; and
at least one swing-arm
protrusion toward the magnet and including a magnetic material so that a bias torque is produced due to formed at the rear end of the swing arm to protrude an interaction with the magnet.

21. The hard disk drive of claim 20, wherein the magnet comprises a first magnetic pole and a second magnetic pole which are positioned so as to be laterally adjacent to each other and have polarities opposite to each other.

22. The hard disk drive of claim 21, wherein the swing-arm protrusion protrudes toward the first magnetic pole so that a clockwise bias torque acts on the swing arm.

23. The hard disk drive of claim 21, wherein the at least one swing-arm protrusion comprises a first swing-arm protrusion protruding toward the first magnetic pole and a second swing-arm protrusion protruding toward the second magnetic pole, so that a clockwise bias torque and a counter-clockwise bias torque act on the swing arm at the same time.

24. The hard disk drive of claim 20, wherein the magnet is positioned above and under the VCM coil to face the VCM coil.

25. The hard disk drive of claim 20, wherein the magnet comprises at least one magnet-protrusion protruding from a body of the magnet toward the swing-arm protrusion so that the bias torque acts on the swing-arm protrusion.

26. The hard disk drive of claim 25, wherein the magnet comprises a first magnet pole and a second magnet pole, and the magnet-protrusion is formed in the first magnetic pole toward which the swing-arm protrusion protrudes, so that the magnet-protrusion and the swing-arm protrusion correspond to each other.

27. The hard disk drive of claim 26, wherein the swing arm comprises an additional swing-arm protrusion protruding toward the second magnetic pole.

28. The hard disk drive of claim 27, wherein the second magnetic pole comprises an additional magnet-protrusion protruding toward the additional swing-arm protrusion.

29. The hard disk drive of claim 25, further comprising:
a ramp to set the read/write head outside the disk,
wherein the swing-arm protrusion and the magnet-protrusion are aligned with each other, so that a separating distance therebetween is shortest when the read/write head enters the ramp.

30. A hard disk drive which includes at least one disk to store information, a spindle to rotate the at least one disk, and an actuator to move a read/write head with respect to the at least one disk, the actuator comprising:
a swing arm to rotate about a pivot, and having a suspension with a read/write head at a front end of the swing arm and a coil-supporting portion with a VCM coil at a rear end of the swing arm;
a magnet disposed to face the VCM coil to generate a main torque with the magnet to rotate the swing arm; and
a protrusion formed on the swing arm to generate a bias torque with the magnet to overcome a resistance applied to the swing arm when the swing arm rotates.
